(19) United States
(12) Patent Application Publication
(10) Pub. No.: US 2016/0271886 A1
(43) Pub. Date: Sep. 22, 2016

(54) RAPID PROTOTYPING APPARATUS

(71) Applicant: MICROJET TECHNOLOGY CO., LTD, Hsinchu (TW)

(72) Inventors: Kwo-Yuan Shi, Hsinchu (TW); Chih-Kai Chen, Hsinchu (TW)

(21) Appl. No.: 15/049,772

(22) Filed: Feb. 22, 2016

(30) Foreign Application Priority Data
Mar. 16, 2015 (TW) 104108382

(51) Int. Cl. B29C 67/00

(52) U.S. Cl. CPC B29C 67/0096; B29C 67/0077; B33Y 30/00

(57) ABSTRACT

A rapid prototyping apparatus includes a construction platform, a movable platform, a first lift/lower mechanism and a second lift/lower mechanism. The construction platform includes a powder feeder, a construction chamber and a powder collector. The powder feeder provides construction powder. A rapid prototyping process is performed in the construction chamber. Excess construction powder is collected in the powder collector. The first lift/lower mechanism is disposed under the powder feeder. The second lift/lower mechanism is disposed under the construction chamber and the powder collector. After the rapid prototyping process is completed, the collected excess construction powder in the powder collector and the excess construction powder in the construction chamber are pushed back to the powder feeder by the powder-pushing element, and the construction powder at a topmost layer of the powder feeder is compacted by the powder-pushing element.

### FIELD OF THE INVENTION

The present invention relates to a rapid prototyping apparatus, and more particularly to a rapid prototyping apparatus for producing a three-dimensional object.

### BACKGROUND OF THE INVENTION

As known, a rapid prototyping (RP) technology is developed from the concepts of forming a pyramid by stacking layers, and the main technical feature is to achieve fast formation. A complicated design can be transformed into a three-dimensional physical model automatically and fast without any cutting tools, molds and fixtures. Thus, the development cycle of new products and research and development cost are largely reduced to ensure the time to market for new products and the first-time-right ratio. Accordingly, a complete and convenient product design tool is provided between technicians and non-technicians (e.g. managers and users), and the product competitiveness and the quick reaction capability of enterprises in the market are improved obviously.

Recently, the rapid prototyping technology develops a method for producing three-dimensional physical models by combining jet printing and precise positioning of carriers. The producing method begins by first spreading a layer of powder on the carrier and then printing high viscosity liquid binder on part of the powder by using jet printing technology, so that the liquid binder and the powder stick together to become solidified. After the above steps are repeatedly done, a three-dimensional physical model is produced by stacking multiple layers.

As known, during the process of constructing the three-dimensional physical model, the construction powder to be spread in the construction chamber should be dense enough. According to the conventional technology, the construction powder is manually compacted in the preliminary stage before the rapid prototyping process is performed. The manual compacting process is time-consuming and labor-intensive. In addition, the flying dust of the construction powder usually pollutes the working environment and contaminates the whole rapid prototyping apparatus. If the worker is exposed to the flying dust for a long time, the flying dust is harmful to the health of the worker.

Moreover, after the excess construction powder recycled to a powder collector, the excess construction powder is manually poured from the powder collector to a powder feeder. The procedure of pouring the excess construction powder to the powder feeder is labor-intensive, complicated and costly. Similarly, the flying dust of the construction powder may pollute the working environment and contaminate the whole rapid prototyping apparatus. The flying dust is also harmful to the health of the worker.

Therefore, there is a need of providing an improved rapid prototyping apparatus in order to overcome the above drawbacks.

### SUMMARY OF THE INVENTION

The present invention provides a rapid prototyping apparatus for automatically pushing back the excess construction powder from a powder collector to a powder feeder, thereby eliminating the drawbacks of the flying dust.

The present invention provides a rapid prototyping apparatus. After a rapid prototyping process is completed, the excess construction powder in a construction chamber and the excess construction powder at the topmost layer of a powder collector are pushed back to the powder feeder by a powder-pushing element. While the powder-pushing element is moved across the topmost layer of the powder feeder, the construction powder at the topmost layer of the powder feeder is compacted by the powder-pushing element. Consequently, the excess construction powder is automatically recycled and automatically compacted. That is, the use of the rapid prototyping apparatus is labor-saving.

In accordance with an aspect of the present invention, there is provided a rapid prototyping apparatus. The rapid prototyping apparatus includes a construction platform, a movable platform, a first lift/lower platform, a first lift/lower mechanism, a second lift/lower platform, a third lift/lower platform and a second lift/lower mechanism. The construction platform includes a powder feeder, a construction chamber and a powder collector. The powder feeder provides construction powder. A rapid prototyping process is performed in the construction chamber. Excess construction powder is collected in the powder collector. The movable platform is disposed on the construction platform and movable relative to the construction platform. A powder-pushing element and a printing module are installed on the movable platform. The first lift/lower platform is disposed within the powder feeder. The first lift/lower mechanism is disposed under the powder feeder for moving the first lift/lower platform in a vertical direction. The second lift/lower platform is disposed within the construction chamber. The third lift/lower platform is disposed within the powder collector. The second lift/lower mechanism is disposed under the construction chamber and the powder collector for synchronously moving the second lift/lower platform and the third lift/lower platform in the vertical direction. After the rapid prototyping process is completed, the collected excess construction powder in the powder collector and the excess construction powder in the construction chamber are pushed back to the powder feeder by the powder-pushing element, and the construction powder at a topmost layer of the powder feeder is compacted by the powder-pushing element.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating a rapid prototyping apparatus according to an embodiment of the present invention; and

FIG. 2 is a schematic cross-sectional view illustrating the rapid prototyping apparatus of FIG. 1.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

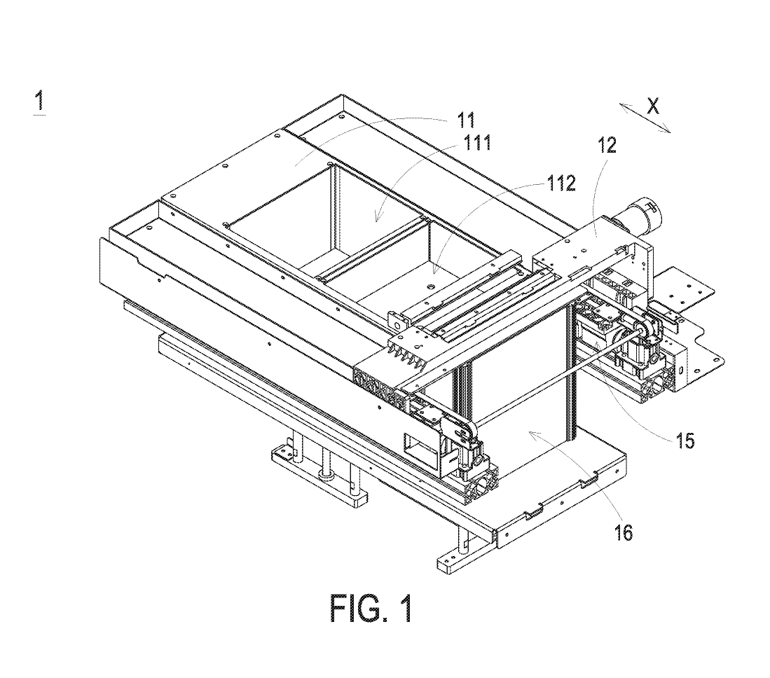

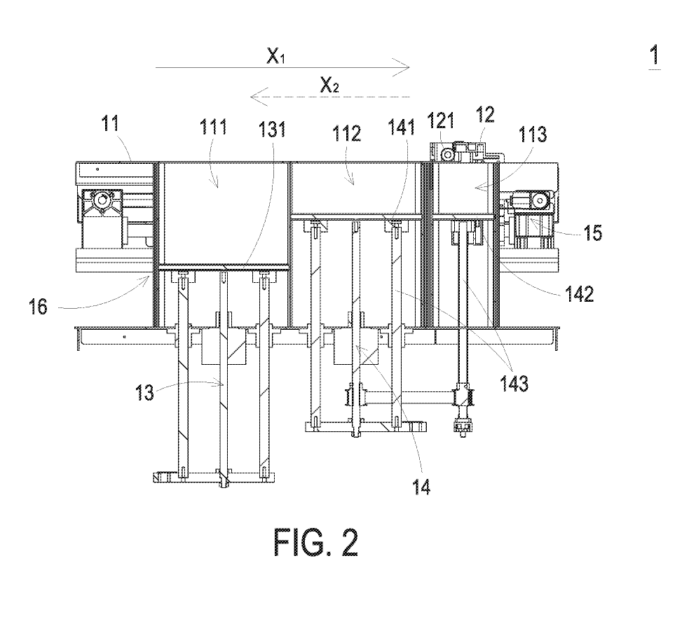

FIG. 1 is a schematic perspective view illustrating a rapid prototyping apparatus according to an embodiment of the present invention. FIG. 2 is a schematic cross-sectional view illustrating the rapid prototyping apparatus of FIG. 1. The rapid prototyping apparatus 1 is used for constructing a three-dimensional physical object. The rapid prototyping apparatus 1 comprises a construction platform 11, a movable platform 12, a first lift/lower mechanism 13 and a second lift/lower mechanism 14. The construction platform 11 is installed on a construction base 16.

Moreover, the construction platform 11 comprises a powder feeder 111, a construction chamber 112 and a powder collector 113. The powder feeder 111 is used for containing construction powder. After multiple layers of the construction powder are sequentially stacked in the construction chamber 112, a three-dimensional physical model is produced. The excess powder from the surface of the three-dimensional physical model is collected by the powder collector 113.

The movable platform 12 is disposed over the construction platform 11. When the movable platform 21 is driven by a driving mechanism 15, the movable platform 12 is horizontally moved relative to the construction platform 11 along the X-axis. An example of the driving mechanism 15 includes but is not limited to a motor.

A first lift/lower platform 131 is disposed within the powder feeder 111. The first lift/lower mechanism 13 is disposed under the powder feeder 111 and connected with the first lift/lower platform 131. The first lift/lower mechanism 13 is used for moving the first lift/lower platform 131 back and forth in a vertical direction.

A second lift/lower platform 141 is disposed within the construction chamber 112. A third lift/lower platform 142 is disposed within the powder collector 113. The second lift/lower mechanism 14 is disposed under the construction chamber 112 and the powder collector 113, and linked with the second lift/lower platform 141 and the third lift/lower platform 142. Accordingly, the second lift/lower mechanism 14 is used for synchronously moving the second lift/lower platform 141 within the construction chamber 112 and the third lift/lower platform 142 within the powder collector 113 back and forth in a vertical direction.

In this embodiment, the powder feeder 111, the construction chamber 112 and the powder collector 113 are concavely formed in the construction platform 11. The construction chamber 112 is arranged between the powder feeder 111 and the powder collector 113. A powder-pushing element 121 and a printing module (not shown) are linked with the movable platform 12. An example of the powder-pushing element 121 includes but is not limited to a roller. While the powder-pushing element 121 is moved in a first direction X1, an amount of the construction powder is pushed to construction chamber 112. While the powder-pushing element 121 is moved in a second direction X2, an amount of the excess construction powder is pushed to the powder feeder 111, and the topmost layer of the excess construction powder is compacted by the powder-pushing element 121. While the printing module is moved with the movable platform 12, liquid binder or ink is printed on the construction powder. Consequently, a construction layer is formed.

A process of performing a rapid prototyping process by the rapid prototyping apparatus 1 will be illustrated as follows. First, the movable platform 12 is moved to a position over the powder feeder 111. Then, as the first lift/lower mechanism 13 pushes the first lift/lower platform 131 upwardly, the first lift/lower platform 131 is moved upwardly within the powder feeder 111. Consequently, an amount of the construction powder in the powder feeder 111 is guided to the topmost layer. At the same time, the second lift/lower platform 141 is moved downwardly by the second lift/lower mechanism 14. Consequently, a spreading space for accommodating the construction powder is defined in the construction chamber 112. Then, as the movable platform 12 is moved, the powder-pushing element 121 is moved from the powder feeder 111 and in the first direction X1. Consequently, the construction powder at the topmost layer of the powder feeder 111 is horizontally pushed to the spreading space of the construction chamber 112. Then, the printing module prints the liquid binder or ink on the construction powder within the construction chamber 112. Consequently, a construction layer is formed. After the above steps are repeatedly done, a three-dimensional object (not shown) is produced by stacking multiple construction layers.

Especially, after each construction layer is formed, the powder-pushing element 121 is continuously moved in the first direction X1. Consequently, the excess construction powder over the construction layer is pushed to the powder collector 113. The collected excess construction powder will be further recycled.

In this embodiment, the second lift/lower mechanism 14 comprises plural support posts 143. The plural support posts 143 are connected with each other. Consequently, the second lift/lower platform 141 within the construction chamber 112 and the third lift/lower platform 142 are linked with the second lift/lower mechanism 14. That is, the second lift/lower mechanism 14 can drive the synchronous movement of the second lift/lower platform 141 and the third lift/lower platform 142 in the vertical direction.

After the rapid prototyping process is completed and the three-dimensional object is removed from the rapid prototyping apparatus 1, some excess construction powder is remained in the construction chamber 112, and some excess construction powder are collected in the powder collector 113. Then, the second lift/lower mechanism 14 pushes upwardly the second lift/lower platform 141 and the third lift/lower platform 142 synchronously. Then, the excess construction powder at the topmost layer of the construction chamber 112 and the excess construction powder at the topmost layer of the powder collector 113 are pushed in the second direction X2 by the powder-pushing element 121. Consequently, the excess construction powder at the topmost layer of the construction chamber 112 and the excess construction powder in the powder collector 113 are pushed back to the powder feeder 111. While the powder-pushing element 121 (e.g., a roller) is moved across the topmost layer of the powder feeder 111, the construction powder at the topmost layer of the powder feeder 111 is pressed by the powder-pushing element 121. Consequently, the construction powder is compacted.

In other words, the powder-pushing element 121 can be moved back and forth on the construction platform 11. While the powder-pushing element 121 is moved in the first direction X1, the construction powder is moved from the powder feeder 111 to the construction chamber 112 for performing the rapid prototyping process, and the excess construction powder is further moved to the powder collector 113 for storage. After the rapid prototyping process is completed, the second lift/lower mechanism 14 drive the synchronous upward movement of the second lift/lower platform 141 and the third lift/lower platform 142. Then, the excess construction powder at the topmost layer of the construction chamber 112 and the excess construction powder within the powder collector 113 are pushed back to the powder feeder 111 in the second direction X2 by the powder-pushing element 121. Consequently, the excess construction powder can be automatically recycled and reused. Moreover, while the powder-pushing element 121 (e.g., a roller) is moved across the topmost layer of the powder feeder 111, the construction powder at the topmost layer of the powder feeder 111 is pressed by the powder-pushing element 121. Consequently, the construction powder is compacted. Since the excess construction powder is automatically recycled and automatically compacted, the use of the rapid prototyping apparatus of the present invention is labor-saving.

From the above descriptions, the present invention provides the rapid prototyping apparatus. After the rapid prototyping process is completed, the excess construction powder at the topmost layer of the construction chamber and the excess construction powder at the topmost layer of the powder collector are pushed back to the powder feeder by the powder-pushing element. While the powder-pushing element is moved across the topmost layer of the powder feeder, the construction powder at the topmost layer of the powder feeder is compacted by the powder-pushing element. Consequently, it is not necessary to perform the preliminary stage of pressing the construction powder before the next rapid prototyping process is performed. Moreover, since the excess construction powder at the topmost layer of the construction chamber and the excess construction powder at the topmost layer of the powder collector are pushed back to the powder feeder, the excess construction powder is automatically recycled and automatically compacted. Moreover, since the excess construction powder is not manually poured from the powder collector to the powder feeder, the drawbacks of the flying dust is minimized. In other words, the rapid prototyping apparatus of the present invention is industrially applicable.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A rapid prototyping apparatus, comprising:
a construction platform comprising a powder feeder, a construction chamber and a powder collector, wherein the powder feeder provides construction powder, a rapid prototyping process is performed in the construction chamber, and excess construction powder is collected in the powder collector;
a movable platform disposed over the construction platform and movable relative to the construction platform, wherein a powder-pushing element and a printing module are installed on the movable platform;
a first lift/lower mechanism disposed under the powder feeder for moving a first lift/lower platform disposed within the powder feeder in a vertical direction; and
a second lift/lower mechanism disposed under the construction chamber and the powder collector for synchronously moving a second lift/lower platform disposed within the construction chamber and a third lift/lower platform disposed within the powder collector in the vertical direction,
wherein the powder-pushing element is moved in a direction so as to push back the collected excess construction powder in the powder collector and the excess construction powder in the construction chamber for recycle, and the construction powder at a topmost layer of the powder feeder is compacted by the powder-pushing element.

2. The rapid prototyping apparatus according to claim 1, wherein the powder-pushing element is a roller.

3. The rapid prototyping apparatus according to claim 1, wherein the second lift/lower mechanism comprises plural support posts, wherein the plural support posts are connected with each other, so that the second lift/lower platform and the third lift/lower platform are linked with the second lift/lower mechanism, wherein the second lift/lower mechanism drives synchronous movement of the second lift/lower platform and the third lift/lower platform in the vertical direction.
